(19) United States
(12) Patent Application Publication
(10) Pub. No.: US 2024/0295035 A1
(43) Pub. Date: Sep. 5, 2024

(54) ELECTROLYTIC CELL FOR POLYMER ELECTROLYTE MEMBRANE ELECTROLYSIS AND METHOD FOR PRODUCTION THEREOF

(71) Applicant: Siemens Energy Global GmbH & Co. KG, Erlangen (DE)

(72) Inventors: Andre Klinger, Nürnberg (DE); Günter Schmid, Hemhofen (DE); Yashar Musayev, Nürnberg (DE); Heinz Neubert, Albershausen (DE)

(21) Appl. No.: 18/572,897

(22) PCT Filed: May 3, 2022
(86) PCT No.: PCT/EP2022/061776

§ 371 Date: Dec. 21, 2023

(30) Foreign Application Priority Data
Jun. 30, 2021 (EP) 21182692.0

(51) Int. Cl. C25B 9/23; C25B 1/04; C25B 11/091; C25B 13/08

(52) U.S. Cl. CPC C25B 9/23; C25B 1/04; C25B 11/091; C25B 13/08

(57) ABSTRACT

The invention relates to an electrolytic cell for polymer electrolyte membrane electrolysis with a cathode half-cell and an anode half-cell, the cathode half-cell and the anode half-cell being separated from one another by means of a polymer electrolyte membrane. The cathode half-cell has a first catalyst material designed to catayse a reduction of molecular oxygen, and a second catalyst material designed to catalyae a reduction of hydrogen ions. The first catalyst material is introduced into a first catalyst layer and the second catalyst material is introduced into a second catalyst layer different from the first catalyst layer, the first catalyst layer being disposed directly adjacent to the second catalyst layer. The invention also relates to a method for producing an electrolytic cell for polymer electrolyte membrane electrolysis.

### BACKGROUND

The invention relates to an electrolysis cell for polymer electrolyte membrane electrolysis, to a process for producing such an electrolysis cell, to the use of such an electrolysis cell and to the use of a catalyst material.

Hydrogen can be obtained by electrolysis from deionized water. The electrochemical cell reactions that proceed are the hydrogen evolution reaction (HER) and oxygen evolution reaction (OER). In the case of acidic electrolysis, the reactions mentioned at the anode and cathode can be defined as follows:

Anode

2H₂O→4H⁺+O₂+4e⁻ (I)

Cathode

H⁺+2e⁻→H₂ (II)

In what is called polymer electrolyte membrane electrolysis (PEM electrolysis), the two part-reactions according to equations (I) and (II) are conducted spatially separately. The reaction spaces are separated by means of a proton-conductive membrane, the polymer electrolyte membrane (PEM), also known by the term proton exchange membrane. The PEM ensures substantial separation of the hydrogen and oxygen product gases, electrical insulation of the electrodes, and conduction of the hydrogen ions as positively charged particles. A PEM electrolysis system is known, for example, from EP 3 489 394 A1. FIG. 1 shows a schematic of the construction of a PEM electrolysis cell according to the prior art.

These cell reactions according to equations (I) and (II) are in equilibrium with their reverse reactions at a cell voltage of 1.48 V, taking account of the increase in entropy on transformation of the liquid water to gaseous hydrogen and oxygen. In order to achieve correspondingly high flows of product in an appropriate time (production output) and hence a flow of current, there is a need for a higher voltage, the overvoltage. PEM electrolysis is therefore conducted at a cell voltage of about 1.8-2.1 V.

The prior art PEM electrolysis cell (see, for example, Kumar, S. et al., Hydrogen production by PEM water electrolysis—A review, Materials Science for Energy Technologies, 2 (3) 2019, 442-454. https://doi.org/10.1016/j.mset.2019.03.002) consists, from the outside inward, of two bipolar plates, gas diffusion layers, catalyst layers and the PEM. High oxidative potentials arise at the anode because of the evolution reaction of oxygen, and therefore materials having fast passivation kinetics, for example titanium, are used for the gas diffusion layer for example.

The potential is less oxidative at the cathode, and so it is possible to manufacture gas diffusion layers from stainless steel. However, these corrode as a result of the acidic medium of the PEM electrolysis inter alia. This corrosion process is called acid corrosion. It is not necessary here for elemental oxygen to be present, since this is provided by the dissociation of the surrounding water. The metal ions at the interface of the metal surface are oxidized by the hydroxide anion to the respective hydroxide salt. This leads to degradation of the cell, which is manifested by an increase in internal resistance and by extrinsic introduction of ions into the PEM.

By way of example, the reactions involved in the formation of Fe (II) hydroxide by acid corrosion are shown below in equations (3) to (6):

Fe→Fe²⁺+2e⁻ (III)

H₂O→H⁺+OH⁻ (IV)

2H⁺+2e⁻→H₂ (V)

Fe²⁺+2OH⁻→Fe(OH)₂ (VI)

If oxygen is additionally present in the electrolyte, this results in what is called oxygen corrosion (equations (VII) to (IX)). Hydroxide ions are provided here directly via the oxygen:

Fe→Fe²⁺+2e⁻ (VII)

O₂+H₂O+2e⁻→2OH⁻ (VIII)

Fe²⁺+2OH⁻→Fe(OH)₂ (IX)

Because there is only a small proportion of dissociated water on account of the strongly acidic medium, it can be assumed that the introduction of oxygen into the electrolyte will lead to a higher hydroxide ion concentration and hence to a distinctly higher corrosion rate of oxygen corrosion by comparison with acid corrosion. The problem of pressure dependence in the above-described what is called oxygen crossover is elucidated in more detail in: Schalenbach, M. et al. Pressurized PEM water electrolysis: Efficiency and gas crossover. Intern. J. Hydr. Ener., 38 (35) 2013, 14921-14933. https://doi.org/10.1016/j.ijhydene.2013.09.013.

It should additionally be noted that, in the case of a high hydroxide ion concentration, i.e. at a high pH (alkaline medium), the whole surface is blocked by an oxide layer. This mechanism is known as passivation, and has the effect that no metal ions are present at the interface and hence the metal can no longer dissolve.

In summary, oxygen in the cathode space thus leads to elevated corrosion rates and low hydrogen purity. The oxygen can be transported from the anode to the cathode via two effects: concentration-driven diffusion and “electroosmotic drag”. The first effect is based on a solution diffusion model of the PEM, in which the oxygen at first dissolves in the polymer at the interface and then migrates onto the cathode side, driven by the concentration gradient. In the case of electroosmotic drag, the oxygen molecules are entrained by the ions moving through the PEM and hence arrive on the cathode side. The latter effect is usually negligible because oxygen has no dipole moment.

The above-described corrosion increases the impedance of the overall system, which means that lower efficiency of the electrolysis process has to be expected. Moreover, the introduction of the dissolved ions from the metal into the PEM can cause lasting damage to the structure thereof, which can have adverse effects on the mechanical stability inter alia. In particular, the gas diffusion layer with its large surface area is predestined for corrosive attack. As a result of the contamination of the hydrogen with oxygen, depending on the intended use of the hydrogen produced, complex purification of the hydrogen is additionally required.

The prior art discloses some approaches to a solution of above-elucidated problems. For instance, the mode of operation of the electrolyzer at low pressure in the anode space and cathode space can reduce the solubility of the oxygen in the PEM, which likewise lowers the permeability of the oxygen through the PEM. This likewise lowers the oxygen concentration in the cathode space. Because of the energy advantages of an electrolysis unit with electrochemical compression, this mode of operation is generally not a solution to the actual problem.

Coating the cathode side of the gas diffusion layers can achieve a certain corrosion stability and hence a stability with respect to attack by oxygen. The production of such coated gas diffusion layers is found to be complex because of the large pores of the gas diffusion layer.

In terms of material, chromium-nickel-base steels having a proportion by mass of nickel of >8% and high chromium contents are preferable because of their fast passivation kinetics. Chromium forms thick CrO₃ passivation layers that are penetrable only with difficulty by oxygen.

However, the aforementioned approaches do not solve the actual problem of oxygen corrosion, but rather merely increase the resistance of the material to this type of corrosion.

The purity of the hydrogen can be increased on an industrial scale according to the prior art (see, for example, Du, Z.; Liu, C.; Zhai, J.; Guo, X.; Xiong, Y.; Su, W.; He, G., A Review of Hydrogen Purification Technologies for Fuel Cell Vehicles. Catalysts 2021, 11, 393. https://doi.org/10.3390/catal11030393) by freezing-out or by means of highly selective membrane methods. A disadvantage of both measures is the high energy requirement.

EP 3 453 785 A1 describes an electrolysis cell in which a cathodic half-cell and an anodic half-cell are connected via a membrane and assembled to form a cell. The cathodic half-cell electively has a cathodic catalyst layer applied to the membrane and a gas diffusion layer applied to the electively provided cathodic catalyst layer. The cathodic catalyst layer here has been applied to the gas diffusion layer, for example, by a sputtering process or by a suspension coating operation. It is alternatively possible, however, that the gas diffusion layer already functions simultaneously as a catalytically active layer, such that there is not even any need for a separate cathodic catalyst layer in the cathodic half-cell. The anodic half-cell is accordingly formed from an anodic catalyst layer and a gas diffusion layer. The gas diffusion layers consist of a respective porous, electrically conductive material. The electrolysis cell of EP 3 453 785 A1 is intended particularly for applications as a polymer electrolyte membrane fuel cell (PEFC), i.e. in fuel cells. Use as an electrolysis cell for production of hydrogen is possible, but there is no more detailed discussion of the problem of the purity of the hydrogen produced in the electrolysis cell and increasing the hydrogen purity.

### SUMMARY

Embodiments include an electrolysis cell for polymer electrolyte membrane electrolysis having a cathodic half-cell and an anodic half-cell, wherein the cathodic half-cell and the anodic half-cell are separated from one another by means of a polymer electrolyte membrane, the cathodic half-cell having a first catalyst material designed for catalysis of a reduction of molecular oxygen and a second catalyst material designed for catalysis of a reduction of hydrogen ions, where the first catalyst material has been introduced into a first catalyst layer and the second catalyst material into a second catalyst layer other than the first catalyst layer, and where the first catalyst layer is arranged directly adjacent to the second catalyst layer.

### DETAILED DESCRIPTION

Against this background, it is an object of the invention to provide an electrolysis cell with which the aforementioned problems can be reduced or even avoided entirely. It is a further object of the invention to specify a process for producing such an electrolysis cell.

This object is achieved by the subject matter of the independent claims. The dependent claims relate to configurations of the solutions of the invention.

A first aspect of the invention relates to an electrolysis cell for polymer electrolyte membrane electrolysis having a cathodic half-cell and an anodic half-cell, wherein the cathodic half-cell and the anodic half-cell are separated from one another by means of a polymer electrolyte membrane. The cathodic half-cell has a first catalyst material designed for catalysis of a reduction of molecular oxygen, and a second catalyst material designed for catalysis of a reduction of hydrogen ions, where the first catalyst material has been introduced into a first catalyst layer and the second catalyst material into a second catalyst layer other than the first catalyst layer, and where the first catalyst layer is arranged directly adjacent to the second catalyst layer.

The two-layer structure for the electrolysis cell of the invention with a first catalyst layer comprising the first catalyst material and with a second catalyst layer comprising a second catalyst material enables spatial and functional separation of the catalysis processes. By virtue of this separation into different catalyst layers, a particularly high hydrogen purity is achievable in the cathodic half-cell, and the oxygen that diffuses into the cathodic half-cell as extrinsic gas can be reduced very efficiently. This distinctly promotes the catalysis of the reduction of molecular oxygen. As a result, the degradation effects resulting from corrosion in the cathodic half-cell that are caused by oxygen migration are prevented. The effect of a barrier layer or barrier is achieved in respect of the penetration of oxygen. By virtue of the arrangement of the first catalyst layer in direct contact with and directly adjacent to the second catalyst layer, a high reaction efficiency is achievable, and a very compact spatial design and enclosure of the co-reactants, which reduces diffusion losses for instance. This distinctly increases the barrier effect of the first catalyst layer with respect to damaging penetration of oxygen into the second catalyst layer and any further layers, for instance a gas diffusion layer. Even in the first catalyst layer, the oxygen can react fully with hydrogen ions and be reduced to water. Disadvantageous corrosion effects are effectively prevented.

With regard to the terms “electrolysis” and “polymer electrolyte membrane” and the reactions and (corrosion) processes that proceed, reference is made to the introductory elucidations. The polymer electrolyte membrane may be formed, for example, from a tetrafluoroethylene-based polymer with sulfonated side groups. The cathodic half-cell forms the reaction space in which the cathode reaction(s) proceed, for example according to equation (II). The anodic half-cell forms the reaction space in which the anode reaction(s) proceed, for example according to equation (I).

By means of the catalyst material, it is possible to reduce molecular oxygen, for example to molecular water according to the following equation (X):

O₂+2H⁺+2e⁻→H₂O (X)

In this way, it is possible to reduce the oxygen content in the cathodic half-cell, such that the processes of oxygen corrosion that are elucidated in the introduction can proceed to a lesser degree or even be avoided entirely. In other words, oxygen corrosion can be actively reduced or even avoided by controlling the cause, namely the presence of oxygen in the cathodic half-cell. By contrast, the measures known from the prior art that are elucidated at the outset merely increase resistance to this type of corrosion, but do not affect the cause thereof.

By reducing or avoiding oxygen corrosion, it is possible to extend the service life of the electrolysis cell and to reduce costs for maintenance and servicing and exchange materials.

Moreover, the reaction product of the electrolysis which is formed in the cathodic half-cell, e.g. hydrogen, is contaminated with oxygen to a lesser degree. It is consequently possible to largely avoid time-and energy-intensive purification of the desired reaction product of the electrolysis.

The electrolysis cell has a second catalyst material designed for catalysis of a reduction of hydrogen ions. The hydrogen thus arrives as extrinsic gas in the second catalyst layer with the second catalyst material already with a much higher purity and lower oxygen concentration, since the oxygen has already been reduced in the first catalyst layer.

Thus, the second catalyst material can bring about a catalytic reduction of hydrogen ions to molecular hydrogen according to equation (II) in the cathodic half-cell, such that hydrogen as the desired reaction product of the electrolysis is formed to a sufficient degree. Possible materials for the second catalyst material are, for example, precious metal compounds, for example platinum, platinum-ruthenium or transition metal compounds. Further suitable materials are described in Yu, J. et al. A mini-review of noble-metal-free electrocatalysts for overall water splitting in non-alkaline electrolytes, Mat. Rep.: Energy, 1 (2) 2021, 100024. https://doi.org/10.1016/j.matre.2021.100024.

The second catalyst material thus contributes in a particularly advantageous manner to an increase in the reaction rate of the cathode reaction(s), and so it is possible to improve the economic viability of the electrolysis.

The first catalyst material has been introduced into a first catalyst layer, and the second catalyst material into a second catalyst layer. This two-layer structure of the invention in the cathodic half-cell brings about spatial and functional separation of the respective catalysis processes, advantageously with prevention of damaging penetration of oxygen into the second catalyst layer.

A layer in the context of the present invention may be understood to mean a sheetlike structure, the measurements of which in the plane of the layer, length and width are distinctly greater than the measurement in the third dimension, the layer thickness.

The introduction of the catalyst materials in layers enables, in a simple manner, the implementation of a definable distribution of the catalyst materials in the cathodic half-cell. Moreover, the handling of the catalyst materials may be facilitated.

It is optionally also possible for the first catalyst material and the second catalyst material to be present collectively in one layer. This can bring the advantage of easier production, since only one layer has to be produced rather than two layers. However, it has been found that the two-layer structure described with the spatial separation leads to a very effective barrier to damaging penetration of oxygen. The oxygen is already reduced virtually completely in the first catalyst layer with the first catalyst material, and therefore the spatial and functional separation of the reactions by means of the two-layer structure is preferable over a common layer.

The first catalyst layer here is arranged adjacent to, preferably directly adjacent to, i.e. in direct contact with, the second catalyst layer. This achieves a particularly simple catalytic two-layer structure in order to enable the catalysis of the respective reaction with simultaneous achievement of spatial separation.

In other words, the first and second catalyst layers in two-dimensional form may directly adjoin one another to form an interface arranged parallel to the planes of the respective layers, i.e. be arranged directly one on top of the other. The second catalyst layer here is arranged adjacent to, preferably directly adjacent to, i.e. in direct and immediate contact with, the polymer electrolyte membrane.

In other words, the likewise two-dimensional polymer electrolyte membrane and the second catalyst layer may directly adjoin one another to form an interface arranged parallel to the plane of the layer, for example be arranged directly one on top of the other.

If the first catalyst layer is likewise arranged adjacent to the second catalyst layer, the result is an arrangement in which the second catalyst layer adjoins the first catalyst layer on one side and the polymer electrolyte membrane on the opposite side.

In the case of such an arrangement, it has been found that it is surprisingly possible to dispense with ionic contacting of the first catalyst layer without any great adverse effect on the catalysis reaction in the first catalyst layer, for example according to equation (X), meaning that the first catalyst material can fulfill the function elucidated above. A non-binding and non-limiting attempt to explain this on the part of the inventors of the present invention is considered to be the presence of acidic process water. In other words, no direct contact between first catalyst layer and polymer electrolyte membrane is required.

In further execution variants, the cathodic half-cell of the electrolysis cell may have a gas diffusion layer. The gas diffusion layer may be arranged adjacent, preferably directly adjacent, to the first catalyst layer.

The gas diffusion layer serves to transport away the gaseous reaction products of the catalytic reaction (s) from the catalyst material (s) and electrical contacting. It can therefore also be referred to as current collector layer or gas diffusion electrode.

The gas diffusion layer of the cathodic half-cell has a porous material to assure gas permeability. It may be manufactured from stainless steel, for example.

By reducing the oxygen concentration in the cathodic half-cell by means of the first catalyst material, it is possible to reduce or even avoid oxygen-accelerated corrosion and the associated degradation of the gas diffusion layer. The service life or lifetime of the gas diffusion layer can be increased.

There may optionally be a channel structure arranged adjacent, preferably directly adjacent, to the gas diffusion layer. The channel structure serves to collect and discharge the gaseous reaction product of the electrolysis in the cathodic half-cell, i.e., for example, hydrogen according to equation (II). The channel structure may take the form, for example, of a bipolar plate. Bipolar plates enable the stacking of two or more electrolysis cells to give an electrolysis cell module, in that it connects the anode of an electrolysis cell to the cathode of an adjacent electrolysis cell in an electrically conductive manner. Moreover, the bipolar plate enables gas separation between mutually adjacent electrolysis cells.

In various execution variants, the first catalyst material may be selected from a group formed by platinum/palladium, platinum/ruthenium, platinum/nickel, platinum/lead/platinum, core-shell catalyst materials, base metal catalyst materials, metal oxides and mixtures thereof.

The notation “metal A/metal B” here means a mixed metal catalyst of metals A and B.

In other words, the first catalyst material may include or consist of one or more of the materials mentioned.

Core-shell catalysts may take the form, for example, of PtPb/Pt catalysts. Base metal catalysts may take the form, for example, of M-N—C composites where M represents transition metal, N represents nitrogen and C represents carbon.

By specific adjustment of the first catalyst material to the reduction of oxygen, for example with regard to the composition and morphology of the corresponding catalyst layer, the required amount of the first catalyst material can be reduced, and so the production costs of the electrolysis cell can likewise be reduced.

In further execution variants, the first catalyst layer may include at least one support material selected from a group formed by carbon black particles, carbon fiber webs, carbon fiber weaves, stainless steel webs, stainless steel weaves and stainless steel meshes.

In other words, the first catalyst layer may include or consist of one or more of the materials mentioned.

The term “mesh” in the present context refers to a fine-mesh network. The support materials mentioned are notable for high corrosion resistance. The terms “mesh” and “weave” describe a directed structure, the term “web” an undirected structure.

The first catalyst material may be applied to the support material. This advantageously enables uniform distribution of the first catalyst material. Moreover, the first catalyst material may be provided with maximum surface area, such that the catalytic effect can be improved with the same amount of first catalyst material or less first catalyst material is required for the same catalytic effect.

In other words, it is an advantage of a support material that a higher specific surface area can be generated, which correspondingly increases the activity of the corresponding catalyst material. A further advantage is the contact points with the second catalyst layer that result from the higher surface area, which increases the contact resistance to the second catalyst layer and improves cross-conductivity.

A further aspect of the invention relates to a process for producing an electrolysis cell for polymer electrolyte membrane electrolysis. The process comprises: providing a polymer electrolyte membrane, forming an anodic half-cell adjoining the polymer electrolyte membrane and forming a cathodic half-cell adjoining the polymer electrolyte membrane, where the cathodic half-cell and the anodic half-cell are separated from one another by the polymer electrolyte membrane and a first catalyst material designed for catalysis of a reduction of molecular oxygen is disposed in the cathodic half-cell, where the first catalyst material is introduced into a first catalyst layer, applying a second catalyst layer comprising a second catalyst material designed for catalysis of a reduction of hydrogen ions to the polymer electrolyte membrane, applying the first catalyst layer to the second catalyst layer, and applying a gas diffusion layer to the first catalyst layer.

By means of the process, it is possible to produce one of the above-described electrolysis cells for polymer electrolyte membrane electrolysis. Accordingly, reference is made to the above elucidations and advantages of these electrolysis cells.

The first catalyst material is introduced here into a first catalyst layer.

In further execution variants, the first catalyst material may be applied to a support material.

The support material with the first catalyst material applied may form the first catalyst layer.

It is also possible and may be advantageous for manufacturing purposes that the first catalyst layer is applied to the gas diffusion layer, for instance by applying the first catalyst material to the gas diffusion layer, in which case it is applied directly atop the gas diffusion layer. The first catalyst layer contains, for example, a fine network of a highly corrosion-stable support material, for example a stainless steel mesh, to which the first catalyst material, for example Pt/Pd, has been applied. The support material here may have been formed at least partly by the material and the structure of the gas diffusion layer itself. The gas diffusion layer then partly forms the support material. The support material is selected, for example, from a group formed by carbon black particles, carbon fiber webs, carbon fiber weaves, stainless steel webs, stainless steel weaves and stainless steel meshes. The first catalyst layer and the gas diffusion layer remain functionally and spatially configured as different layers in a directly adjacent arrangement. The first catalyst layer and the second catalyst layer are likewise spatially and functionally different layers with a respective layer material, such that a two-layer system is formed. This two-layer system has been applied to the gas diffusion layer, such that, as a result, a layer system having at least three spatially and functionally different layers has been applied atop the polymer electrolyte membrane in the cathodic half-cell, comprising the second catalyst layer, the first catalyst layer and the gas diffusion layer.

The first catalyst material may be applied to the support material, for example, by chemical gas phase deposition (CVD) and/or physical gas phase deposition (PVD).

Application by chemical gas phase deposition may be preferable in the case of porous structures and support materials, whereas application by physical gas phase deposition may be preferable in the case of non-porous structures. Both chemical gas phase deposition and physical gas phase deposition advantageously enable the production of thin layers having a layer thickness in the region of a few nanometers to a few micrometers. It is thus possible to save catalyst material.

The forming of the cathodic half-cell has the following steps: applying a second catalyst layer with a second catalyst material designed for catalysis of a reduction of hydrogen ions to the polymer electrolyte membrane, applying the first catalyst layer to the second catalyst layer, and applying a gas diffusion layer to the first catalyst layer.

These steps achieve a two-layer structure in a particularly advantageous manner in the process, the achievement of spatial and functional separation of the respective catalysis process for the reaction of the hydrogen ions and the reduction of the oxygen molecules to water.

It is optionally possible for the formation of the cathodic half-cell to further include applying of a channel structure to the gas diffusion layer.

The expression “applying to” in the present context does not necessarily mean specific spatial arrangement in the sense of “on top”. What this is instead intended to express is merely that the layers mentioned are arranged adjacent to one another. It is also possible for the sequence of process steps to be reversed or altered, meaning that the cathodic half-cell can alternatively be formed proceeding from the gas diffusion layer or the channel structure. Further in the alternative, it is also possible to choose one of the middle layers, for example the gas diffusion layer or the first catalyst layer, as the starting point, to which the respectively adjacent layers are applied on either side.

The structure of the anodic half-cell may be analogous, i.e. a catalytic layer for catalysis of the anode reaction, for example according to equation (I) , may be applied to the opposite lateral face of the polymer electrolyte membrane from the second catalyst layer, a gas diffusion layer may be applied thereto, and a channel structure, for example in the form of a bipolar plate, may optionally be applied thereto. The materials used for the purpose may preferably be matched to the conditions prevailing in the anodic half-cell, for example with regard to their corrosion resistance.

A further aspect of the invention relates to the use of an electrolysis cell according to the above description for electrolytic production of hydrogen.

In other words, the reactions according to equations (I) and (II) may be performed in the cathodic and anodic half-cells when electrical current flows through the electrolysis cell.

A further aspect of the invention relates to the use of a catalyst material for catalysis of a reduction of molecular oxygen in a cathodic half-cell of an electrolysis cell.

The catalyst material may, for example, be the above-described first catalyst material, and so reference is made to the elucidations and advantages in this regard.

### BRIEF DESCRIPTION OF THE FIGURES

There follows elucidation of the invention by way of example with reference to the appended figures in terms of embodiments, and the features described hereinafter may constitute an aspect of the invention either on their own or in various combinations with one another. The figures show:

FIG. 1 a schematic diagram of an electrolysis cell for polymer electrolyte membrane electrolysis according to the prior art;

FIG. 2 a schematic diagram of an illustrative electrolysis cell; and

FIG. 3 a flow diagram of an illustrative process.

### DESCRIPTION OF THE FIGURES

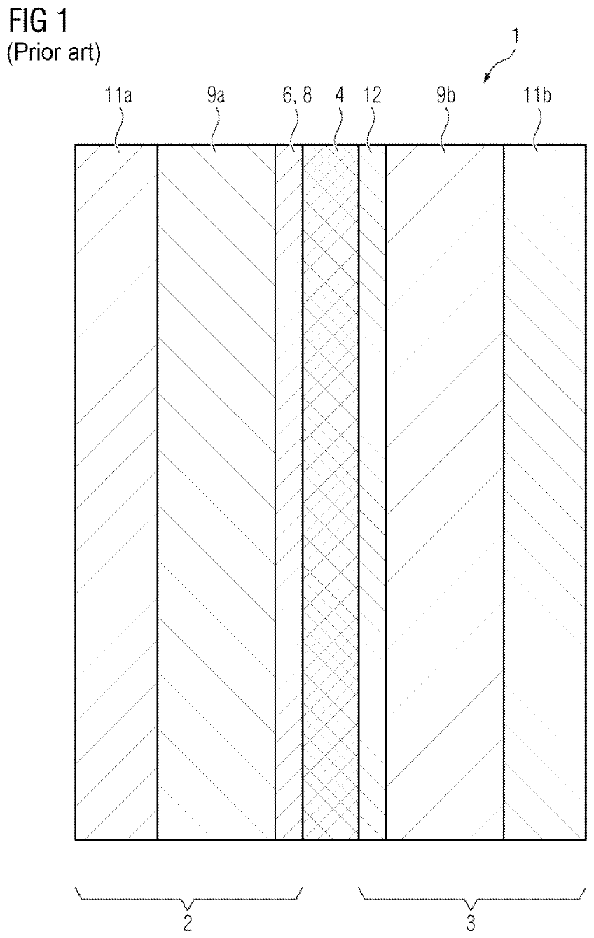

FIG. 1 shows an electrolysis cell 1 for polymer electrolyte membrane electrolysis according to the prior art in a schematic diagram. The electrolysis cell 1 serves for electrolytic production of hydrogen.

The electrolysis cell 1 has a polymer electrolyte membrane 4. On one side of the polymer electrolyte membrane 4, on the left in the diagram according to FIG. 1, is disposed the cathodic half-cell 2 of the electrolysis cell 1, and on the other side of the polymer electrolyte membrane 4, on the right in the diagram according to FIG. 1, is disposed the anodic half-cell 3 of the electrolysis cell 1.

The anodic half-cell 3 comprises an anodic catalyst layer 12 directly adjacent to the polymer electrolyte membrane 4, a gas diffusion layer 9b directly adjacent to the anodic catalyst layer 12, and a channel structure 11b directly adjacent to the gas diffusion layer 9b. The anodic catalyst layer 12 catalyzes the anode reaction according to equation (I). In order to reduce corrosion, the gas diffusion layer 9bhas been produced from a material on the surface of which a passivation layer forms rapidly, for example from titanium. The channel structure 11b takes the form of a bipolar plate, so as to enable stacking of two or more electrolysis cells 1.

The cathodic half-cell 2 comprises a catalyst layer 8 having a catalyst material 6 directly adjacent to the polymer electrolyte membrane 4. The catalyst material 6 is designed for catalysis of a reduction of hydrogen ions, especially to molecular hydrogen according to equation (II). Likewise disposed atop the catalyst layer 8 is a gas diffusion layer 9a. By contrast with the gas diffusion layer 9b of the anodic half-cell 3, the gas diffusion layer 9a of the cathodic half-cell 2 is manufactured from stainless steel. This is possible because of the lower oxidation potential in the cathodic half-cell 2 compared to the anodic half-cell 3, and reduces the costs of the electrolysis cell 2. Likewise directly adjacent to the gas diffusion layer 9a is a channel structure 11a which, analogously to the anodic half-cell 3, takes the form of a bipolar plate.

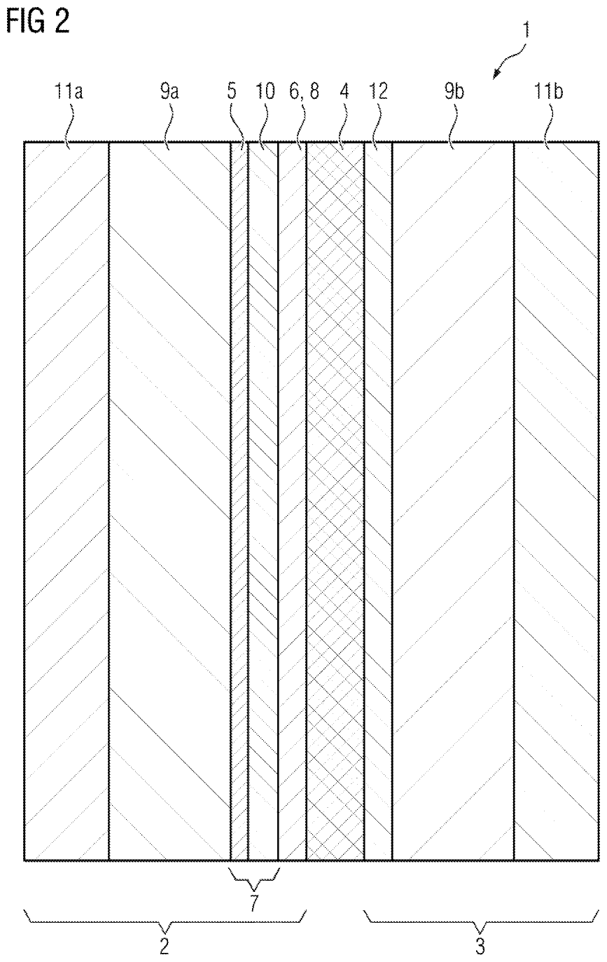

A disadvantage of the electrolysis cell 1 known from the prior art is, as elucidated at the outset, the propensity of the materials in the cathodic half-cell 2 to corrosion with regard to the acid corrosion promoted by elemental oxygen. Moreover, the hydrogen produced in the cathodic half-cell 2 is contaminated by oxygen. In order to remedy these disadvantages, it is proposed that a first catalyst material 5 be introduced into the cathodic half-cell, which is designed for catalysis of a reduction of molecular oxygen, especially according to equation (X), i.e. to form water. Such a modified electrolysis cell 1 is shown schematically by way of example in FIG. 2.

The anodic half-cell 3 of the working example of an electrolysis cell 1 which is shown in FIG. 2 is constructed analogously to the electrolysis cell according to FIG. 1, and so reference may be made to the remarks in this regard.

The cathodic half-cell 2, likewise in analogy with the electrolysis cell according to FIG. 1, has a gas diffusion layer 9a and a channel structure 11a. A second catalyst layer 8 with a second catalyst material 6 is likewise directly adjacent to the polymer electrolyte membrane 4, where the second catalyst material 6 is designed for catalysis of the reduction of hydrogen ions, especially to molecular hydrogen according to equation (II).

By contrast with the electrolysis cell 2 according to FIG. 1, a first catalyst layer 7 is firstly directly adjacent to the first catalyst layer 8. The first catalyst layer 7 consists of a fine network of a highly corrosion-stable support material 10, for example a stainless steel mesh, to which the first catalyst material 5, e.g. Pt/Pd, has been applied.

The first catalyst material 5 is designed for catalysis of the reduction of molecular oxygen according to equation (X), i.e. water is formed from molecular oxygen. As a result, there is a decrease in the oxygen concentration in the cathodic half-cell 2, and it is possible to reduce oxygen-promoted corrosion, especially of the gas diffusion layer 9a. The consequence is a longer lifetime, especially of the gas diffusion layer. Moreover, reduced corrosion can enable the use of less costly materials in the cathodic half-cell 2.

Moreover, the electrolytically produced hydrogen is also contaminated to a lesser degree with oxygen, meaning that the purity of the product hydrogen is increased. A small proportion of oxygen in the hydrogen produced lowers the complexity for a subsequent purification which is needed for various applications. The hydrogen produced is thus upgraded.

The hydrogen thus arrives with a distinctly lower oxygen content at the gas diffusion layer 9a, which is directly adjacent to the first catalyst layer 7, and then leaves the electrolysis cell 2 via the channel structure 11adirectly adjacent to the gas diffusion layer 9a with high purity. The water formed in the catalytic reaction of the first catalyst material 5 according to equation (X) is removed together with the gas stream.

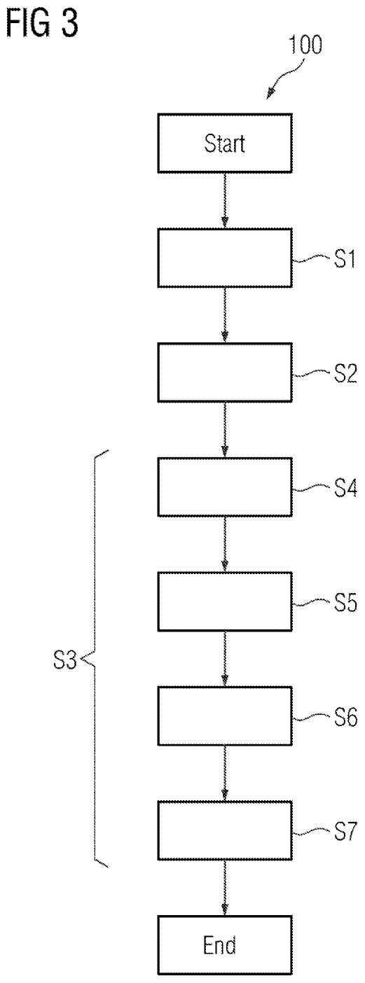

FIG. 3 shows a flow diagram of an illustrative process 100 for producing an electrolysis cell 1, for example the electrolysis cell 1 shown in FIG. 2.

After the start of the process 100, in step S1, a polymer electrolyte membrane 4 is provided. Subsequently, in step S2, an anodic half-cell 3 adjoining the polymer electrolyte membrane 4 is formed. For this purpose, the anodic catalyst layer 12, the gas diffusion layer 9b and the channel structure 11b may be arranged correspondingly one on top of another, for example deposited one on top of another.

In step S3, the cathodic half-cell 2 is formed, likewise adjoining the polymer electrolyte membrane 4, but on the opposite side from the anodic half-cell 3. In this case, the first catalyst material 4 designed for catalysis of a reduction of molecular oxygen is disposed in the cathodic half-cell 2. Steps S2 and S3 may also be performed in a temporary parallel manner or in the reverse sequence.

Step S3 has component steps S4 to S7, i.e. the cathodic half-cell 2 is formed in the working example by means of steps S4 to S7. In step S4, a second catalyst layer 8 with a second catalyst material 6, which is designed for catalysis of a reduction of hydrogen ions to molecular hydrogen, is applied to the opposite side of the polymer electrolyte membrane 4 from the anodic half-cell 2.

In step S5, a first catalyst layer 7 is subsequently applied to the second catalyst layer 8. The second catalyst layer 8 contains the first catalyst material 5. In order to form the second catalyst layer 7, a support material 10 is first provided, on the surface of which the first catalyst material 5 is applied by chemical gas phase deposition and/or physical gas phase deposition.

In step S6, a gas diffusion layer 9a is applied to the first catalyst layer 7 before, in step S7, a channel structure 11a in the form of a bipolar plate is applied to the gas diffusion layer 9a.

It should be noted that the cathodic half-cell 2 may also be formed proceeding from the channel structure 11a. In other words, the starting point chosen may be the channel structure 11a, to which are applied firstly the gas diffusion layer 9a, then the first catalyst layer 7, then the second catalyst layer 8, and finally the polymer electrolyte membrane 4. A corresponding procedure is possible for the anodic half-cell 3. Consequently, the layers and structures of the electrolysis cell 1 may alternatively also be constructed proceeding from the channel structure 11a of the cathodic half-cell 2 or proceeding from the channel structure 11b of the anodic half-cell 3.

It is also possible and may be advantageous for manufacturing purposes that the first catalyst layer 7 is applied to the gas diffusion layer 9a, for instance by applying the first catalyst layer 5 to the gas diffusion layer 9a, the application being effected directly atop the gas diffusion layer 9a. The first catalyst layer 7 contains, for example, a fine network of a highly corrosion-stable support material 10, for example a stainless steel mesh, to which the first catalyst material 5, for example Pt/Pd, has been applied. The support material 10 may be formed at least partly by the material and the structure of the gas diffusion layer 9a itself. The gas diffusion layer 9a then forms the support material 10 which is selected, for example, from a group formed by carbon black particles, carbon fiber webs, carbon fiber weaves, stainless steel webs, stainless steel weaves and stainless steel meshes.

It will be apparent that other embodiments can also be utilized and structural or logical changes can be undertaken without departing from the scope of the present invention. For instance, features of the working example described herein can be combined with one another, unless specifically stated otherwise. The description of the working example should therefore not be considered in a restrictive manner, and the scope of protection of the present invention is defined by the appended claims.

The expression “and/or” used here, in the case of utilization in a series of two or more elements, means that any of the elements listed may be used alone, or it is possible to use any combination of two or more of the elements listed.

1. An electrolysis cell for polymer electrolyte membrane electrolysis having a cathodic half-cell and an anodic half-cell, wherein the cathodic half-cell and the anodic half-cell are separated from one another by means of a polymer electrolyte membrane, the cathodic half-cell having:
a first catalyst material designed for catalysis of a reduction of molecular oxygen,
a second catalyst material designed for catalysis of a reduction of hydrogen ions, where the first catalyst material has been introduced into a first catalyst layer and the second catalyst material into a second catalyst layer other than the first catalyst layer, and where the first catalyst layer is arranged directly adjacent to the second catalyst layer.

2. The electrolysis cell as claimed in claim 1, wherein the second catalyst layer is arranged directly adjacent to the polymer electrolyte membrane.

3. The electrolysis cell as claimed in claim 1, the cathodic half-cell having:
a gas diffusion layer arranged directly adjacent to the first catalyst layer.

4. The electrolysis cell as claimed in claim 1, wherein the first catalyst material is selected from a group formed by platinum/palladium, platinum/ruthenium, platinum/nickel, platinum/lead/platinum, core-shell catalyst materials, base metal catalyst materials, metal oxides and mixtures thereof.

5. The electrolysis cell as claimed in claim 1, wherein the first catalyst layer includes at least one support material selected from a group formed by carbon black particles, carbon fiber webs, carbon fiber weaves, stainless steel webs, stainless steel weaves and stainless steel meshes.

6. A process for producing an electrolysis cell for polymer electrolyte membrane electrolysis, the process comprising:
providing a polymer electrolyte membrane,
forming an anodic half-cell adjoining the polymer electrolyte membrane,
forming a cathodic half-cell adjoining the polymer electrolyte membrane, where the cathodic half-cell and the anodic half-cell are separated from one another by the polymer electrolyte membrane and a first catalyst material designed for catalysis of a reduction of molecular oxygen is disposed in the cathodic half-cell, where the first catalyst material is introduced into a first catalyst layer, applying a second catalyst layer comprising a second catalyst material designed for catalysis of a reduction of hydrogen ions to the polymer electrolyte membrane,
applying the first catalyst layer to the second catalyst layer, and
applying a gas diffusion layer to the first catalyst layer.

7. The process (100) for producing an electrolysis cell (1) as claimed in claim 6, wherein the first catalyst material (5) is applied to a support material (10).Ca

8. The process as claimed in claim 6, wherein the first catalyst material is applied to the support material by chemical gas phase deposition and/or physical gas phase deposition.

9. The use of an electrolysis cell (1) as claimed in any of claims 1 to 5 for electrolytic production of hydrogen.

10. The use of a catalyst material (5) for catalysis of a reduction of molecular oxygen in a cathodic half cell (2) of an electrolysis cell (1) as claimed in any of claim 1 or 5.
